(19) United States
(12) Patent Application Publication
(10) Pub. No.: US 2007/0041188 A1
(43) Pub. Date: Feb. 22, 2007

(54) Snap on Christmas lights!

(76) Inventors: John Frank Angelos, Baton Rouge, LA (US); Gwendolyn Crawford Angelos, Baton Rouge, LA (US)

Correspondence Address: JOHN ANGELOS / GWENDULYN ANGELOS, 11817 PARKMOUNT BLVD., BATON ROUGE, LA, 70816, US

(21) Appl. No.: 11/205,844

(22) Filed: Aug. 18, 2005

(51) Int. Cl. F21V 21/00

(52) U.S. Cl. 362/249

(57) ABSTRACT

Setting up a lights display on a Christmas tree is usually fun, but sometimes is accompanied with frustration over individual lights that do not work, causing either the whole strand or half the strand not to stay lit. Snap on Christmas Lights! offer an alternative in that each light has its own power source, which enables the user to position a light anywhere on the tree. It also enables the user to change only the bulb or battery that is faulty without having either half or the whole strand fail, or struggling to determine which light has failed.

Christmas lights that be attached to a standard Christmas tree without wires. These lights can be placed on any branch at the discretion of the user. The lights are attached by a snap located on the side of the socket. Watch batteries located in the base of the socket power these lights. The lights are turned off and on by a hand held device much similar to a remote used for TV/DVD/VCR players. For outdoor use, a non-electrical wire attached to the base of the socket connecting the lights to form a strand for traditional use.

### BACKGROUND OF THE INVENTION

1. Field of the Invention

The present invention relates to lighted holiday decoration relates to lighted ornaments for a Christmas tree.

2. Description of the Prior Patents

The use of lighted devices on holiday decorations that attach to a Christmas Tree in the form of a string are well known. Various types of lighted string can be found which include a series of light bulbs in various voltages strung together. When lighted the effect is of many small points of light.

Over time there have been numerous innovations for Christmas tree lights that are described in the cited patents as references. Even though these innovations may be suitable for the specific individual purposes to which they address, they differ from the present invention.

### PAST PATENTS AS CITED REFERENCES

In U.S. Pat. No. 5,542,636, dated Aug. 06, 1996, titled Clips for Supporting Miniature Christmas Lights at Any of a Plurality of Locations, invented by John P. Mann, Files on Nov. 23, 1994, a clip for supporting miniature Christmas lights at any of a plurality of locations comprising an one-piece clip fabricated of a plastic material with limited resilience. Alight supporting component is formed in a generally C-shaped configuration about a vertical axis of rotation. The supporting component is greater than 180 degrees and less than 190 degrees. A second component is formed integrally with the first component. The second component is adapted to be secured to a recipient surface to maintain the first component and the supportive bulb in a vertical orientation.

In U.S. Pat. No. 5,245,519, issued Sep. 14, 1993, titled Multi-Branched Christmas Lights, invented by Renato M. Openiano, filed on Feb. 18, 1992, an ornamental Christmas light decorating system containing one or more clusters of flashing lights, which can be shaped by an user and attached to a various surfaces. The cluster provides a perception of directional movement or chasing of light.

In U.S. Pat. No. 5,526,931, issued Jun. 18, 1996, titled Carrier for Long, Flexible Elements Such as Chrstmas Lights, invented by Dallas White, filed on Oct. 12, 1994, a carrier includes a base and handle on each end of that base with the handles being coaxial with the central axis of the base so that long, flexible elements, such as Christmas lights, that are to be stored on the carrier can be easily wound on to the carrier as well as unwound from that carrier. A plurality of arms is included and cavities are located near the central axis for releasable accommodating electrical plugs associated with the flexible elements. One embodiment of the carrier has handles fixed to a base, and a second embodiment has a swivel connection between the base and the handles. Hook receivable holes are defined in the handles on the central axis whereby the carrier can be pendently supported for storage.

In U.S. Pat. No. 5,388,802, titled Method and apparatus for suspending Christmas lights underneath eaves on a house, filed Jan. 13, 1994 invented by William B. Dougal & Murry Nesbitt, issued on Feb. 14, 1995, a method of suspending Christmas lights underneath eaves of a house finished with aluminum or vinyl soffit panels and fascia. Firstly, attach a plurality of wedge shaped members to a string of Christmas lights. Secondly, insert the wedge shaped members between the fascia and soffit of the house. The Christmas lights protrude perpendicularly below the fascia and are clearly visible from adjacent street while the wedge shaped members are hidden from view by the fascia.

In U.S. Pat. No. 5,024,406, filed Jan. 31, 1990, titled Device for Hanging Outdoor Christmas Lighting, filed Jun. 18, 1991, invented by Raymond H. Ketcham, a hanging outdoor Christmas light holder for a lamp socket fixture is provided and consists of a removable attaching member having as first component that is permanently attachable to a static structure on a building, while a second mating component is carried on underside of the lamp socket fixture so that the lamp socket fixture can be quickly and simply attached thereto and removed there from.

In U.S. Pat. No. Des. 298,738, titled Clip for Christmas Lights, invented by Donald D. Rumpel, filed on May 15, 1986, issued on Nov. 29, 1988, an ornamental design for a clip for Christmas lights.

In U.S. Pat. No. Des. 351,915, titled Set of Transparent Christmas Lights, invented by Terry Hermanson, filed on Feb. 7, 1992, issued on Oct. 25, 1994, an ornamental design for a clip for a set of transparent Christmas lights.

In U.S. Pat. No. Des. 331,360, titled Hook for Supporting Christmas Lights Adjacent Roofing Shingles, invented by William E. Adams, filed May 08, 1991, issued Dec. 1, 1992, an ornamental design for a hook for supporting Christmas lights.

In U.S. Pat. No. Des. 361,032, titled Clip for Hanging Christmas Lights, invented by William B. Dougan, filed Jun. 11, 1993, issued Aug. 08, 1995, an ornamental design for a clip for hanging Christmas lights.

In U.S. Pat. No. Des. 340,846, titled Implement Head for Relocating Christmas Lights, invented by David J. Nichols, Jr., filed Jun. 18, 1991, issued Nov. 2, 1993, an ornamental design for an implement head for relocating Christmas lights.

In U.S. Pat. No. Des. 345,430, titled Set of Battery Powered Miniature Christmas Lights, invented by Jerry D. Ridgeway, filed Sep. 23, 1991, issued Mar. 22, 1994, an ornamental design for a set of battery powered miniature Christmas lights.

The above-patented inventions differ from the present invention because (with the exception of one reference), these past inventions required an electric current from a wall socket to operate. The Snap on Christmas lights function to provide an easier and faster way to apply lights to a Christmas tree. Easier because of a fastening snap that secures the light to desired position on the tree. Because each light has it own power source, if any light were to fail, the user could easily locate and replace the battery or light without having any other lights fail. A faulty connected bulb or fuse causes half or the entire strand not to function in traditional electric light strands.

### SUMMARY OF THE INVENTION

Holiday lighting consisting of multiple light bulbs is created by inserting colored bulbs in a hollow shape having optical properties that cause it to become illuminated from the light of the bulb. Snap on Christmas Lights follow the same hollow shape, the different in that each light has a snap on attachment enabling the user to position individual lights on any branch of the tree. Another distinction is that each light has its own power source i.e. (watch battery) that eliminates the need for electricity.

The types of problems encountered in traditional electric light strands are solved for the following reasons:
1. In traditional string lights sets, half of the set may fail because one or more bulbs may be broken or shorted out, or there may be a bad fuse in the connection end. By each light having its own power source, locating a bad bulb or dead battery is easier for the user.
2. String lights have to be placed on the Christmas tree is a specific pattern. Snap on Christmas Lights enable the user to position the light at any point on the tree.
3. String lights have a maximum connection capacity of 3 strands per outlet.
4. Using watch batteries eliminates the need for electricity, thus saving the consumer on energy bills. Estimated life span of watch batteries is about three years.
5. Lights can be place on any branch or in any position by the user, thus allowing the user flexibility and creativity in designing a light display on the tree. If the desired use is for outdoor displays, the lights would be attached to a non-electric wire to form a tradition strand of lights to be hung on bushes/eaves/windows/door frames/roof tops or any other application to provide a more traditional outdoor lighting display.

### BRIEF DESCRIPTION OF THE DRAWINGS

FIG. 1 is a view of a typical Christmas light

FIG. 2 is a side view of the Christmas light showing the opening in the socket into which a watch battery is to be inserted.

FIG. 3. is front and side of the fastening mechanism to attach the light to the tree. The snap is show in the open and closed position.

FIG. 4. is view of the inside of the light socket.

FIG. 5. is a view of the remote used to operate the lights.

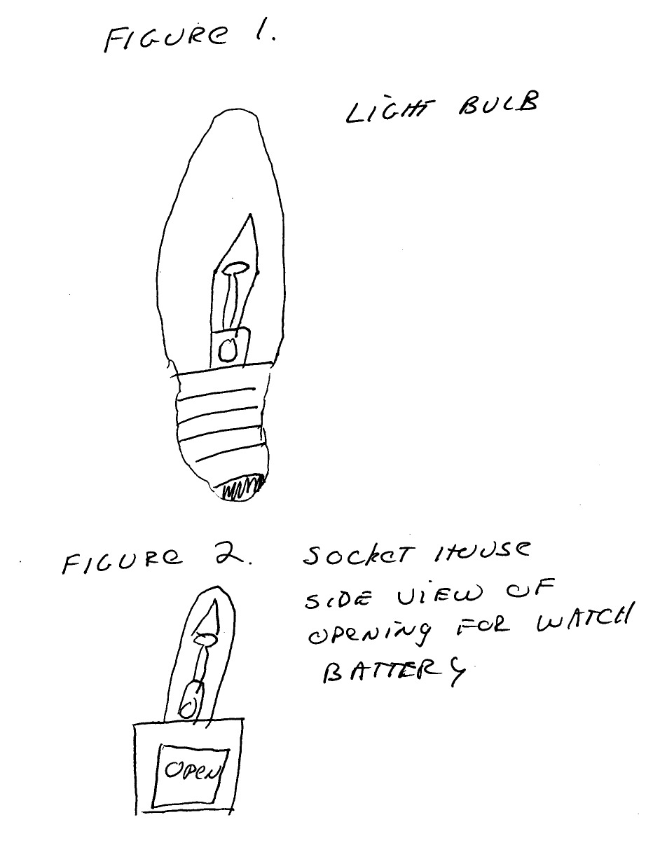

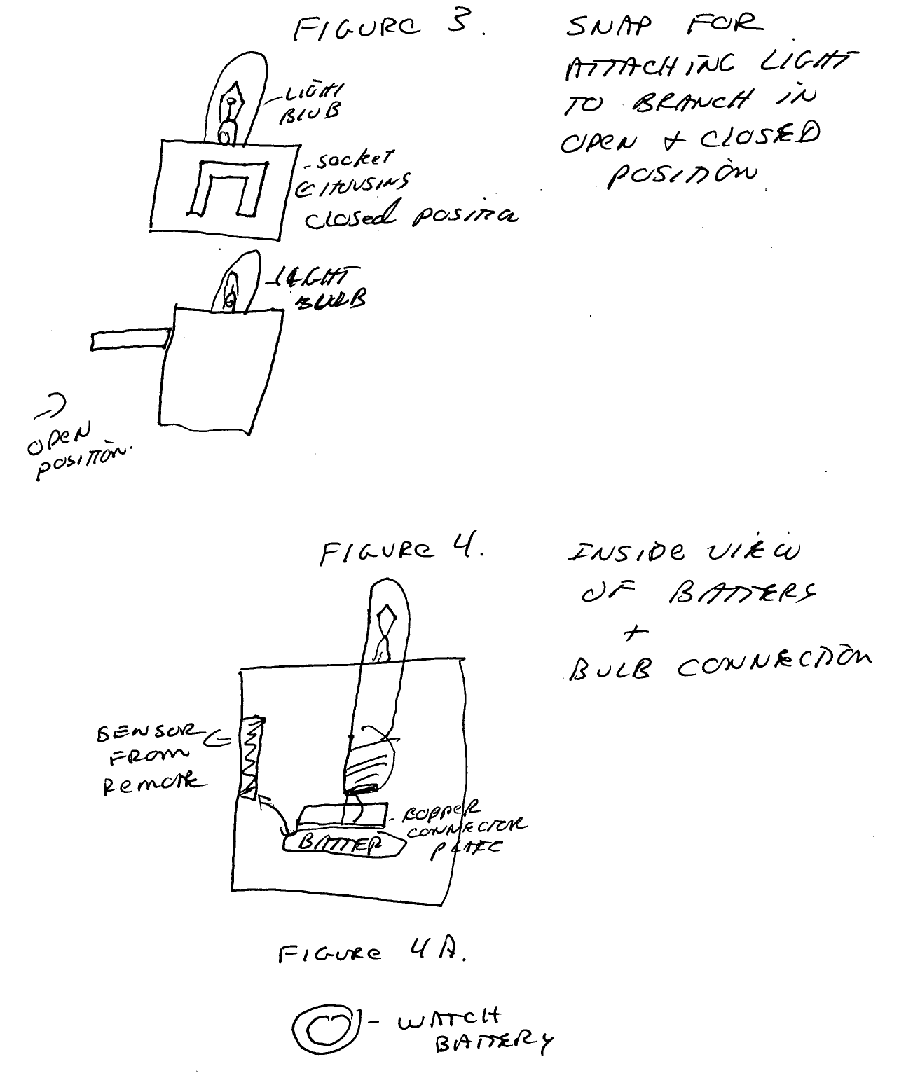

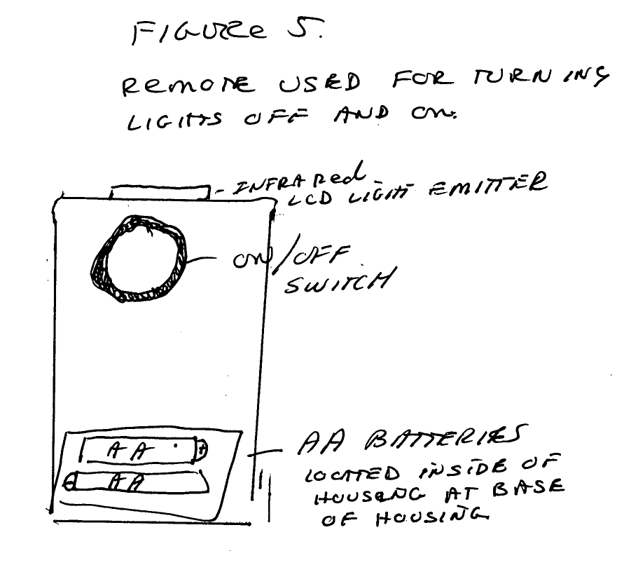

While the invention has been illustrated and described as Christmas tree lights, it is not intended to be limited to the details shown, since it will be understood that various omissions, modifications, substitutions and changes in the forms and details of the device illustrated and in its operation can be made by those skilled in the art without departing in any way from the spirit of the present invention.

### REFERENCES CITED

U.S. Pat. Nos.:
5,632,551, Roney et al., May 1997
6,288,498, Cheng, September 2001
6,294,983, Lee, September 2001
6,309,086, Tomlinson, October 2001
6,341,440, Lee, January 2002
6,404,131, Kawano et al., June 2002

What is claimed is:

1. A decorative light set of 150 to 300 colored miniature lights or a set of 50 regular sized colored Christmas lights comprising of:
A) powered by watch batteries;
B) lights are turned off and on by a remote.

2. The decorative light set wherein the material is selected from a group consisting of plastic, plastic composites, glass, crystal, rubber, rubber composite, fiberglass, epoxy, and carbon-graphite.

3. The decorative light set as described in claim 1, wherein the light housing has a non-electrical wire securely attaching the lights in a strand formation for outdoor use.
